(19) United States
(12) Patent Application Publication
(10) Pub. No.: US 2026/0257680 A1
(43) Pub. Date: Sep. 3, 2026

(54) DRIVER EMULATING ADAPTIVE CRUISE CONTROL

(71) Applicants: FCA US LLC, Auburn Hills, MI (US); Stellantis Auto SAS, Poissy (FR)

(72) Inventors: Ronald Reese, II, Auburn Hills, MI (US); Alexander George, Auburn Hills, MI (US); Drushan Mavalankar, Auburn Hills, MI (US); Chunjian Wang, Auburn Hills, MI (US)

(21) Appl. No.: 19/066,249

(22) Filed: Feb. 28, 2025

(51) Int. Cl. B60W 30/16; B60W 30/18

(52) U.S. Cl. CPC B60W 30/16; B60W 30/18027; B60W 2520/10; B60W 2540/10; B60W 2540/12; B60W 2540/30; B60W 2554/4041; B60W 2554/4042; B60W 2554/802; B60W 2555/60; B60W 2720/106; B60W 2754/30

(57) ABSTRACT

A driver emulating adaptive cruise control (ACC) system and method for a vehicle include a memory storing a personalized driving style machine learning model configured to model a driving behavior of a particular driver of the vehicle and a control system configured to access, from the memory, the personalized driving style machine learning model, based on the personalized driving style machine learning model, calibrate a gain value for controlling longitudinal acceleration of an ACC feature of the vehicle, and execute the ACC feature using the calibrated gain value to emulate the driving behavior of the particular driver.

### FIELD

The present application generally relates to vehicle autonomous driving and, more particularly, to systems and methods for driver emulating adaptive cruise control.

### BACKGROUND

Some vehicles include autonomous driving features where the vehicle automatically (i.e., without driver intervention) controls certain aspects of vehicle operation. One example of such autonomous driving features is adaptive cruise control (ACC). In contrast to conventional vehicle cruise control where the driver sets a cruise control speed and then manually participates, ACC involves the vehicle automatically following behind a front vehicle at a safe distance, including both accelerating and braking. Conventional ACC features are tuned to a predetermined gain or setting that controls how aggressive the vehicle accelerates/brakes. Every driver, however, may have different driving habits. For example, some drivers may be more cautious and accelerate/brake slower than other more aggressive drivers. Thus, the conventional ACC features may be perceived by the driver to be inadequate or different than normal driving. Accordingly, while such conventional ACC features do work well for their intended purpose, there exists an opportunity for improvement in the relevant art.

### SUMMARY

According to one example aspect of the invention, a driver emulating adaptive cruise control (ACC) system for a vehicle is presented. In one exemplary implementation, the driver emulating ACC system comprises a memory storing a personalized driving style machine learning model configured to model a driving behavior of a particular driver of the vehicle and a control system configured to access, from the memory, the personalized driving style machine learning model, based on the personalized driving style machine learning model, calibrate a gain value for controlling longitudinal acceleration of an ACC feature of the vehicle, and execute the ACC feature using the calibrated gain value to emulate the driving behavior of the particular driver.

In some implementations, the control system is configured to execute the ACC feature based further on a distance between the vehicle and a front vehicle and a safety distance threshold. In some implementations, the control system is further configured to train the personalized driving style machine learning model based on a plurality of driving parameters of the vehicle during each of a plurality of driving maneuvers of the vehicle by the particular driver. In some implementations, the plurality of driving parameters includes at least one of (i) a speed of the vehicle, (ii) a current speed limit of a road on which the vehicle is traveling, and (iii) a speed of a front vehicle that the vehicle is following or a speed limit for a next speed zone that the vehicle will traverse, and (iv) a distance to the front vehicle or the next speed zone. In some implementations, the plurality of driving parameters includes at least (i) the speed of the vehicle, (ii) the current speed limit of the road on which the vehicle is traveling, and (iii) the speed of the front vehicle or the speed limit for the next speed zone, and (iv) the distance to the front vehicle or the next speed zone.

In some implementations, the plurality of driving maneuvers include a car-following maneuver where the particular driver controls the vehicle while following a front vehicle. In some implementations, the plurality of driving maneuvers include a free-driving maneuver where the particular driver controls at least one of acceleration and braking of the vehicle without following a front vehicle. In some implementations, the plurality of driving maneuvers include a launching maneuver where the particular driver controls the vehicle to accelerate and launch from a standstill. In some implementations, the plurality of driving maneuvers include a stopping maneuver where the particular driver controls the vehicle to decelerate and stop the vehicle. In some implementations, the personalized driving style machine learning model is separately trained and stored at the memory for each of a plurality of different drivers of the vehicle including the particular driver, and the control system is configured to differently calibrate the gain value for the ACC feature for at least some of the plurality of different drivers based on their respective separately trained and stored personalized driving style machine learning models.

According to another example aspect of the invention, a method for performing driver emulating ACC for a vehicle is presented. In one exemplary implementation, the method comprises storing, by a memory of the vehicle, a personalized driving style machine learning model configured to model a driving behavior of a particular driver of the vehicle, accessing, by a control system of the vehicle and from the memory, the personalized driving style machine learning model, based on the personalized driving style machine learning model, calibrating, by the control system, a gain value for controlling longitudinal acceleration of an ACC feature of the vehicle, and executing, by the control system, the ACC feature using the calibrated gain value to emulate the driving behavior of the particular driver.

In some implementations, the executing of the ACC feature by the control system is based further on a distance between the vehicle and a front vehicle and a safety distance threshold. In some implementations, the method further comprises training, by the control system, the personalized driving style machine learning model based on a plurality of driving parameters of the vehicle during each of a plurality of driving maneuvers of the vehicle by the particular driver. In some implementations, the plurality of driving parameters includes at least one of (i) a speed of the vehicle, (ii) a current speed limit of a road on which the vehicle is traveling, and (iii) a speed of a front vehicle that the vehicle is following or a speed limit for a next speed zone that the vehicle will traverse, and (iv) a distance to the front vehicle or the next speed zone. In some implementations, the plurality of driving parameters includes at least (i) the speed of the vehicle, (ii) the current speed limit of the road on which the vehicle is traveling, and (iii) the speed of the front vehicle or the speed limit for the next speed zone, and (iv) the distance to the front vehicle or the next speed zone.

In some implementations, the plurality of driving maneuvers include a car-following maneuver where the particular driver controls the vehicle while following a front vehicle. In some implementations, the plurality of driving maneuvers include a free-driving maneuver where the particular driver controls at least one of acceleration and braking of the vehicle without following a front vehicle. In some implementations, the plurality of driving maneuvers include a launching maneuver where the particular driver controls the vehicle to accelerate and launch from a standstill. In some implementations, the plurality of driving maneuvers include a stopping maneuver where the particular driver controls the vehicle to decelerate and stop the vehicle. In some implementations, the personalized driving style machine learning model is separately trained and stored at the memory for each of a plurality of different drivers of the vehicle including the particular driver, and the control system is configured to differently calibrate the gain value for the ACC feature for at least some of the plurality of different drivers based on their respective separately trained and stored personalized driving style machine learning models.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of a vehicle having an example driver emulating adaptive cruise control (ACC) system according to the principles of the present application;

FIGS. 2A-2B are diagrams of example vehicle operating scenarios and data for training a personalized driving style machine learning model for a driver according to the principles of the present application; and

FIG. 3 is a flow diagram of an example method for obtaining a trained personalized driving style model and for employing the trained model for ACC control in a vehicle according to the principles of the present application.

### DESCRIPTION

As previously discussed, some vehicles include autonomous driving features where the vehicle automatically (i.e., without driver intervention) controls certain aspects of vehicle operation. In contrast to conventional vehicle cruise control where the driver sets a cruise control speed and then manually participates, adaptive cruise control (ACC) is an autonomous driving feature that involves the vehicle automatically following behind a front vehicle at a safe distance, including both accelerating and braking. Conventional ACC features are tuned to a predetermined gain or setting that controls how aggressive the vehicle accelerates/brakes. Every driver, however, may have different driving habits. For example, some drivers may be more cautious and accelerate/brake slower than other more aggressive drivers. Thus, the conventional ACC features may be perceived by the driver to be inadequate or different than normal driving.

Accordingly, systems and methods for driver emulating ACC are presented. These systems and methods generate a personalized driving style machine learning model (e.g., a neural network model) that models a particular driver's style. Each driver of a vehicle can have their own trained/stored model. This model learns or is taught over time based on driving parameters (speeds, distances, etc.) during free-driving and car-following operating scenarios, including acceleration/launch and deceleration/stopping maneuvers by the particular driver. The above-described gain can then be tuned based on the model, thereby providing a desired (expected) acceleration during ACC and an improved driver experience and acceptance of ACC as an autonomous driving feature.

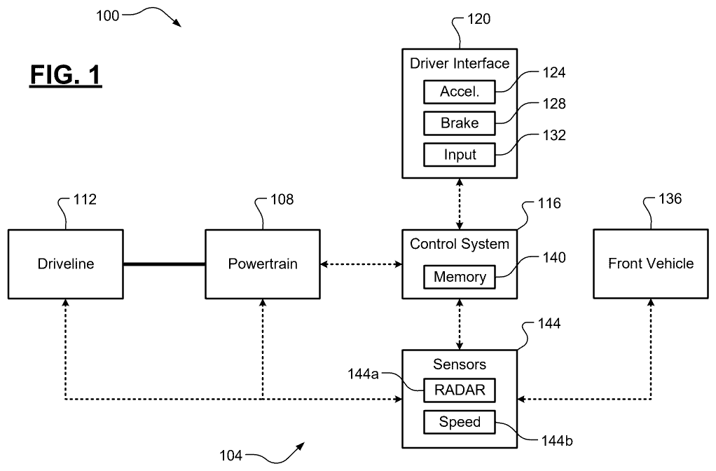

Referring now to FIG. 1, a functional block diagram of a vehicle 100 having an example driver emulating ACC system 104 (also “ACC control system 104” herein) according to the principles of the present application is illustrated. The vehicle 100 generally comprises a powertrain 108 that generates and transfers drive torque to a driveline 112 for vehicle propulsion. The powertrain 108 could have any suitable configuration (engine-only, hybrid, electric-only, etc.) and thus could comprise an internal combustion engine, an electric motor, or some combination thereof, as well as a transmission or gearbox and possibly other components (a torque converter, a disconnect clutch, etc.). The driveline 112 includes components that are driven by the drive torque generated by the powertrain 108 such as, but not limited to, a differential, axles or half-shafts, and wheels/tires. It will be appreciated that these are merely example components of the vehicle 100 and that the vehicle 100 could be any suitably equipped vehicle having an ACC system or feature.

A control system 116 controls operation of the vehicle 100, which primarily includes controlling the powertrain 108 to generate and transfer to the driveline 112 a sufficient amount of drive torque to satisfy a driver torque request, which could be provided by a driver of the vehicle 100 via an accelerator pedal 124 or similar device that is part of a driver interface 120. The driver interface 120 could also include a brake pedal 128 or similar device that allows the driver to provide a brake request to control a brake system (not shown) of the vehicle 100 and an input device 132 (a button, a touch display, etc.) configured to receive a request from the driver to enable/disable an ACC feature. The driver interface 120 could further include other non-illustrated components, such as a steering wheel for controlling a steering system (not shown) of the vehicle 100.

As previously discussed, the ACC feature includes the vehicle 100 automatically controlling acceleration/braking of the vehicle 100 to maintain a safety distance threshold from a front vehicle 136. As this involves automated controls of various components of the vehicle 100, the ACC feature is executable by the control system 116 of the vehicle 100. The control system 116 also comprises a memory 140, which is configured to store personalized driver behavior machine learning model(s) that are discussed in greater detail below. The term “front vehicle” as used herein refers to another car or vehicle that is traveling immediately in front of the vehicle 100 along a current road or highway (i.e., with no intermediary cars or vehicles therebetween). The front vehicle 136 thus could be another car or vehicle that is currently traveling in the same lane as the vehicle 100 along a multi-lane road or highway. When the vehicle 100 changes lanes (e.g., moving to a left or passing lane), there may no longer be a front vehicle 136 present and thus the ACC feature could cause the vehicle 100 to accelerate (e.g., to perform a passing maneuver on a road or highway).

However, when one of the vehicle 100 and the front vehicle 136 changes lanes, that other car or vehicle will no longer be the front vehicle 136 relative to the vehicle 100. As discussed above, the ACC feature involves the control system 116 monitoring operating parameters and environmental conditions, which is performed using a plurality of sensors 144. The plurality of sensors 144 include, but are not limited to, position/speed/acceleration sensors, radio detection and ranging (RADAR) sensors, light detection and ranging (LIDAR) sensors, and camera systems (front-facing, side-facing, rear-facing, etc.). For purposes of the present application, the plurality of sensors 144 include at least a RADAR sensor 144a and a vehicle speed sensor 144b, which represent the minimum hardware requirements for executing the ACC feature.

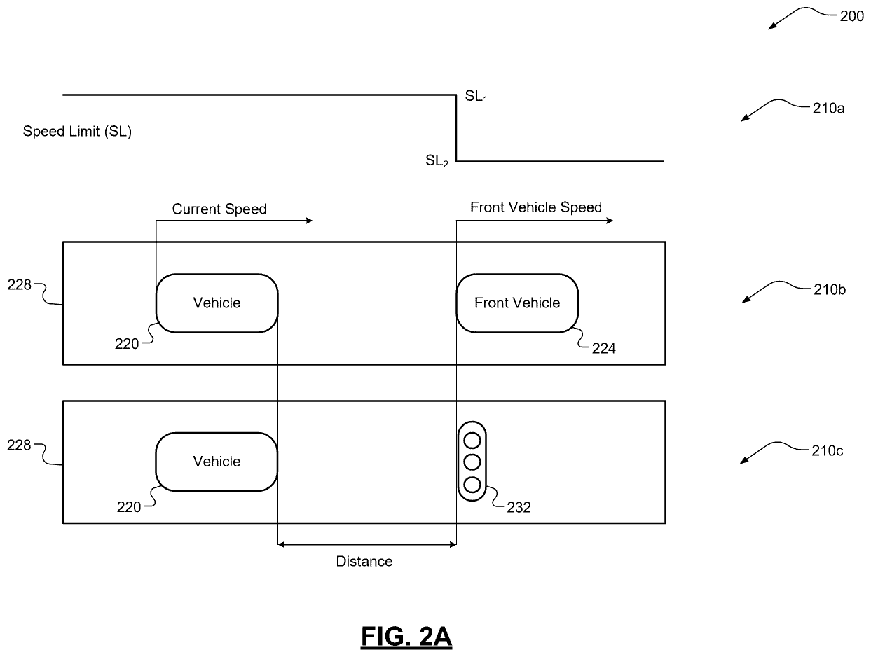

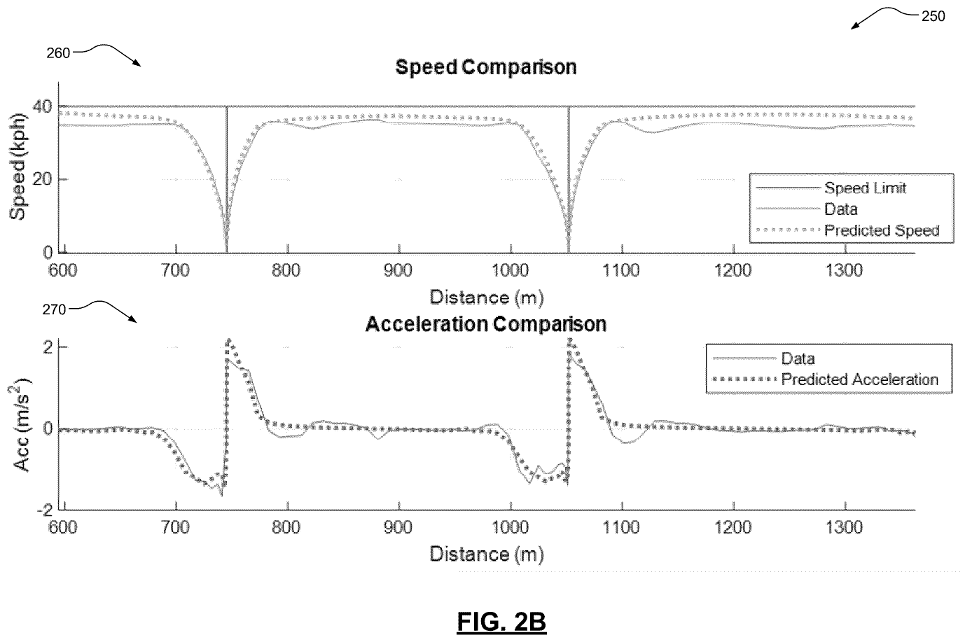

Referring now to FIGS. 2A-2B and with continued reference to FIG. 1, diagrams 200 and 250 of example vehicle operating scenarios and data for training a personalized driving style machine learning model for a driver according to the principles of the present application are illustrated. As discussed above, a personalized driving style machine learning model (also “machine learning model” or “model” herein) is generated and trained to model a driving behavior of a particular driver of the vehicle 100. In some embodiments, multiple drivers of the vehicle 100 could each have their own trained/stored personalized driving style machine learning model stored in the memory 140 of the control system 116 of the vehicle 100. The machine learning model could be any suitable type of machine learning model, such as a neural network model. The machine learning model is initially generated and then trained based on driving or operating parameters of the vehicle 100 (speeds, distances, etc.) during various different types of driving operating scenarios and driver maneuvers as discussed in greater detail below. In FIG. 2A, three different driving operating scenarios 210a, 210b, and 210c for training the machine learning model are illustrated.

In the first operating scenario 210a of FIG. 2A, a difference between the speed of the vehicle 100 is monitored (e.g., using vehicle speed sensor 144a) relative to a speed limit of a road along which the vehicle 100 is traveling. This could also be referred to herein as a free-driving scenario where there is no front vehicle present. When there is an upcoming change in the speed limit (e.g., in a future region or segment of the road), such as the illustrated drop from a first speed limit (SL₁) to a lower speed limit (SL₂), the acceleration/braking of the vehicle 100 is monitored to determine how aggressive the particular driver operates the vehicle 100. For example, some drivers may consistently drive at a certain speed lower than the speed limit (e.g., 10 miles per hour less) whereas other drivers may more aggressively drive at the speed limit. In FIG. 2B, an upper plot 260 of the plots 250 shows the trained machine learning model predicting a vehicle speed that is somewhere between the actual vehicle speed data (Data) and the speed limit. In the lower plot 270 of FIG. 2B, predicted acceleration/deceleration is also shown (in response to various speed limit drops or vehicle stop regions along a route) relative to the actual vehicle acceleration/deceleration data (Data).

In the second operating scenario 210b of FIG. 2A, the speed and position of the vehicle 100 (vehicle 220) is monitored (e.g., using the sensors 144) relative to speeds/positions the front vehicle 136 (vehicle 224). This is also referred to herein as a vehicle-following or car-following operating scenario, which could further include deceleration/stopping and launching maneuvers (from a standstill). The relative positions of the vehicles 220, 224 could be measured as a distance therebetween (e.g., using the RADAR sensor 144b). In a third operating scenario 210c of FIG. 2A, the speed and position of the vehicle (vehicle 220) is monitored (e.g., using the sensors 144) relative to an upcoming traffic control device 232 (a stop sign, a traffic light, a speed limit sign, etc.) that will cause the vehicle 220 to decelerate and possible stop at a standstill. After stopping to a standstill, a launch maneuver could then be executed. Again, as shown in the plots 260, 270 of FIG. 2B, vehicle acceleration/deceleration data during the various vehicle maneuvers (launch, stopping, etc.) of operating scenarios 210b, 210c are monitored over time and used to train the machine learning model.

The output of the machine learning model changes as it is trained such that it generates more accurate predicted vehicle speed/acceleration/ deceleration relative to the collected data during training. It will be appreciated that the machine learning model could require a certain amount of training data before it is verified as capable of being used for gain-tuning of the ACC feature. It will also be appreciated that the machine learning model could continue to be trained over time, as the habits or behaviors of the driver could also change over time (e.g., he/she could become more cautious or more aggressive over time). For example, each time a particular driver begins driving the vehicle, he/she could be identified (via a key fob, via a driver input, via camera/facial recognition, etc.) to load their respective machine learning model for training and/or usage. Once the machine learning model is sufficiently trained (e.g., by verifying its accuracy relative to the training data), it can then be used to tune a gain value of the ACC feature, which will now be discussed in greater detail below.

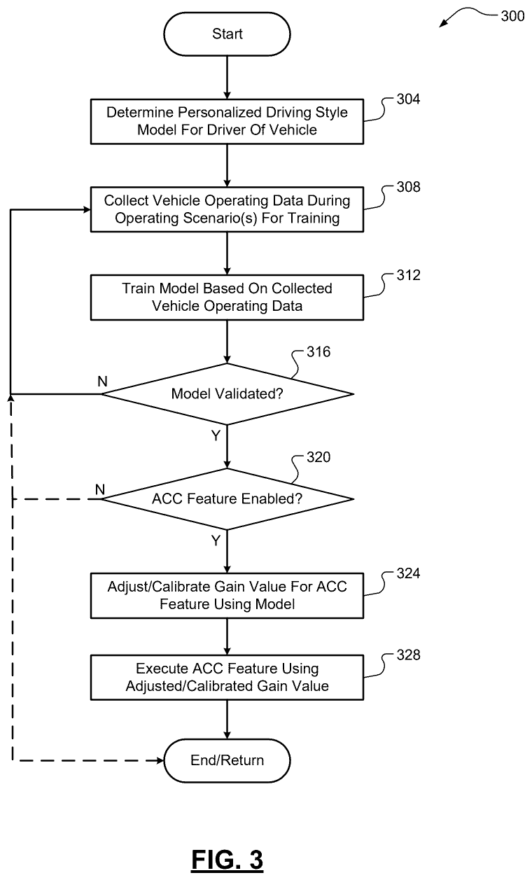

Referring now to FIG. 3 and with continued reference to FIGS. 1 and 2A-2B, an example method 300 for obtaining a trained personalized driving style model and for employing the trained model for ACC control in a vehicle according to the principles of the present application is illustrated. While the method 300 specifically references the vehicle 100 and its components, it will be appreciated that the method 300 could be applicable to any suitably equipped vehicle having an ACC system or feature. The method 300 begins at 304 where the control system 132 determines a personalized driving style machine learning model for a driver of the vehicle 100. This could include, for example, determining an identify of the driver of the vehicle 100 and accessing the memory 140 to retrieve his/her stored machine learning model. In some cases, the particular driver may not yet have an established personalized driving style machine learning model. In such cases, the control system 116 could generate a new (default) machine learning model and associate it with the particular driver and store it in the memory 140. Once the control system 116 has access to the machine learning model for the driver of the vehicle 100, the method 300 proceeds to 308. At 308, the control system 116 collects vehicle operating data during the various vehicle operating scenarios previously discussed herein.

At 312, the control system 116 trains the machine learning model based on this collected vehicle operating data as previously discussed herein. At optional 316, the control system 116 could verify or validate that the machine learning model has been sufficiently trained such that it can be employed for usage with the ACC feature of the vehicle 100. When false, the method 300 could return to 304 or 308 where further training could occur. When true, the method 300 could proceed to 320. At 320, the control system 116 determines whether the ACC feature has been enabled or requested by the driver of the vehicle 100 (e.g., via a driver input via input device 132 of the driver interface 120). When false, the method 300 ends or returns to 304 or 308 for further training of the machine learning model. When true, the method 300 proceeds to 324. At 324, the control system 116 adjusts or calibrates the gain value for the ACC feature using the machine learning model. As previously discussed, the machine learning model is configured to model how aggressive the driver operates the vehicle 100 in order to model or mimic their behavior for control of the ACC feature. In some embodiments, the machine learning model is configured to output the gain value for use by the ACC feature. In other embodiments, the machine learning model could be configured to output a modifier (e.g., a multiplier) for the gain value.

At 328, the control system 116 executes the ACC feature using the adjusted/calibrated gain value. As previously discussed, the ACC feature generally involves the control system 116 maintaining a safety distance threshold between the vehicle 100 and the front vehicle 136, which could be monitored using the RADAR sensor(s) 144a and/or other similar sensors 144 (LIDAR sensor(s), camera system(s), etc.). The gain value could be used to control vehicle acceleration and deceleration relative to the front vehicle 136. For example, a higher gain value could correspond to more aggressive acceleration/braking. It will also be appreciated that separate gain values could be used for acceleration and braking. For example, a particular driver could be heavy/aggressive on the accelerator pedal 124 while light/cautious on the brake pedal 128. The method 300 then ends or returns to 304 (e.g., after the current run of the ACC feature or after the ACC feature has been disabled). For example only, after a key-off cycle, the method 300 could return to 304 and another driver could subsequently key-on the vehicle 100, after which his/her personalized driving style machine learning model could be accessed/generated and subsequently trained/utilized, depending on the above-described conditions.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A driver emulating adaptive cruise control (ACC) system for a vehicle, the driver emulating ACC system comprising:
a memory storing a personalized driving style machine learning model configured to model a driving behavior of a particular driver of the vehicle; and
a control system configured to:
access, from the memory, the personalized driving style machine learning model;
based on the personalized driving style machine learning model, calibrate a gain value for controlling longitudinal acceleration of an ACC feature of the vehicle; and
execute the ACC feature using the calibrated gain value to emulate the driving behavior of the particular driver.

2. The driver emulating ACC system of claim 1, wherein the control system is configured to execute the ACC feature based further on a distance between the vehicle and a front vehicle and a safety distance threshold.

3. The driver emulating ACC system of claim 1, wherein the control system is further configured to train the personalized driving style machine learning model based on a plurality of driving parameters of the vehicle during each of a plurality of driving maneuvers of the vehicle by the particular driver.

4. The driver emulating ACC system of claim 3, wherein the plurality of driving parameters includes at least one of (i) a speed of the vehicle, (ii) a current speed limit of a road on which the vehicle is traveling, and (iii) a speed of a front vehicle that the vehicle is following or a speed limit for a next speed zone that the vehicle will traverse, and (iv) a distance to the front vehicle or the next speed zone.

5. The driver emulating ACC system of claim 4, wherein the plurality of driving parameters includes at least (i) the speed of the vehicle, (ii) the current speed limit of the road on which the vehicle is traveling, and (iii) the speed of the front vehicle or the speed limit for the next speed zone, and (iv) the distance to the front vehicle or the next speed zone.

6. The driver emulating ACC system of claim 3, wherein the plurality of driving maneuvers include a car-following maneuver where the particular driver controls the vehicle while following a front vehicle.

7. The driver emulating ACC system of claim 3, wherein the plurality of driving maneuvers include a free-driving maneuver where the particular driver controls at least one of acceleration and braking of the vehicle without following a front vehicle.

8. The driver emulating ACC system of claim 3, wherein the plurality of driving maneuvers include a launching maneuver where the particular driver controls the vehicle to accelerate and launch from a standstill.

9. The driver emulating ACC system of claim 3, wherein the plurality of driving maneuvers include a stopping maneuver where the particular driver controls the vehicle to decelerate and stop the vehicle.

10. The driver emulating ACC system of claim 1, wherein:
the personalized driving style machine learning model is separately trained and stored at the memory for each of a plurality of different drivers of the vehicle including the particular driver, and
the control system is configured to differently calibrate the gain value for the ACC feature for at least some of the plurality of different drivers based on their respective separately trained and stored personalized driving style machine learning models.

11. A method for performing driver emulating adaptive cruise control (ACC) for a vehicle, the method comprising:
storing, by a memory of the vehicle, a personalized driving style machine learning model configured to model a driving behavior of a particular driver of the vehicle;
accessing, by a control system of the vehicle and from the memory, the personalized driving style machine learning model;
based on the personalized driving style machine learning model, calibrating, by the control system, a gain value for controlling longitudinal acceleration of an ACC feature of the vehicle; and
executing, by the control system, the ACC feature using the calibrated gain value to emulate the driving behavior of the particular driver.

12. The method of claim 11, wherein the executing of the ACC feature by the control system is based further on a distance between the vehicle and a front vehicle and a safety distance threshold.

13. The method of claim 11, further comprising training, by the control system, the personalized driving style machine learning model based on a plurality of driving parameters of the vehicle during each of a plurality of driving maneuvers of the vehicle by the particular driver.

14. The method of claim 13, wherein the plurality of driving parameters includes at least one of (i) a speed of the vehicle, (ii) a current speed limit of a road on which the vehicle is traveling, and (iii) a speed of a front vehicle that the vehicle is following or a speed limit for a next speed zone that the vehicle will traverse, and (iv) a distance to the front vehicle or the next speed zone.

15. The method of claim 14, wherein the plurality of driving parameters includes at least (i) the speed of the vehicle, (ii) the current speed limit of the road on which the vehicle is traveling, and (iii) the speed of the front vehicle or the speed limit for the next speed zone, and (iv) the distance to the front vehicle or the next speed zone.

16. The method of claim 13, wherein the plurality of driving maneuvers include a car-following maneuver where the particular driver controls the vehicle while following a front vehicle.

17. The method of claim 13, wherein the plurality of driving maneuvers include a free-driving maneuver where the particular driver controls at least one of acceleration and braking of the vehicle without following a front vehicle.

18. The method of claim 13, wherein the plurality of driving maneuvers include a launching maneuver where the particular driver controls the vehicle to accelerate and launch from a standstill.

19. The method of claim 13, wherein the plurality of driving maneuvers include a stopping maneuver where the particular driver controls the vehicle to decelerate and stop the vehicle.

20. The method of claim 11, wherein:
the personalized driving style machine learning model is separately trained and stored at the memory for each of a plurality of different drivers of the vehicle including the particular driver, and
the control system is configured to differently calibrate the gain value for the ACC feature for at least some of the plurality of different drivers based on their respective separately trained and stored personalized driving style machine learning models.
